(19) United States
(12) Patent Application Publication
(10) Pub. No.: US 2008/0262918 A1
(43) Pub. Date: Oct. 23, 2008

(54) Exercise recommendation engine and internet business model

(76) Inventor: Jay Wiener, San Jose, CA (US)

Correspondence Address: Walt Froloff, 273D Searidge Rd, Aptos, CA, 95003, US

(21) Appl. No.: 11/788,166

(22) Filed: Apr. 19, 2007

(51) Int. Cl. G06Q 30/00

(52) U.S. Cl. 705/14

(57) ABSTRACT

The present invention discloses a system and method for accepting personal exercise data on selected muscle or muscle groups and making numerical, statistical and comparative analysis on the data to derive recommendations on progress, future exercise or current physical regimen modification. The recommendations to the user may be accompanied by contacts to vendors of products and services which may aid in implementation of or enable some of the recommendations. The vendor contacts register and establish their recommendation remedies with the model system which accepts the personal data and links the users and clients together at recommendation time.

### BACKGROUND

### Field of the Invention

The present invention generally relates to acquiring physical exercise and/or physiological data and applying human performance metrics to recommend equipment and or services which further the therapeutic or general interests of users. More specifically, the physical exercise regime taken by users is monitored for progress and recommendations contain specific product or service solutions which are engaged with providers of the recommended product or services in fulfillment of a plurality of fitness and health application needs.

The general area of physical exercise data processing and management has grown at a phenomenal rate, as more is learned about the human body and as technology delivers more convenient ways and means of tapping in and processing data.

The area of physical exercise contains a large diversity of products and services. The challenge is to provide a physical exercise regime which grows with the client's immediate progress, and using external as well as internal data, to make real and continuous and automated recommendations, some of which translate to the purchase of identified products or services along the lines of physical improvement and therapeutic enhancement of individual efforts in very specific and unique regimens with real-time monitoring and exercise data processing.

Concurrently, vendors seek ways to satisfy customer immediate and future needs in the most efficient and timely manner. Although the recommendation engine will seek to find solutions to exercise without need for additional equipment or services, on occasion some recommendations will reach out. Thus linking individuals who seek to improve and focus on specific physical objectives through exercise are often not knowledgeably synchronized with timely available products and services which can impact or synergize their custom unique performance requirements or physical regimen. A physical exercise private trainer or physical therapist may help in many aspects of the physical regimen but many individuals do not take this route for cost and other reasons. Knowledgeable and individual unique recommendations may also be limited to the equipment and services which an individual has on hand or available. Thus there is a need for an automated system comprehensive device which is product/service aware, and individual situation unique and timely recommendation specific.

For example, many common devices such as ropes, steel cables, and webbing, linked with electronics, can help a user measure strength during an isometric or isotonic contraction at selected achievable ranges of motion, and at selected achievable angles to the body and/or floor. Exercise equipment such as BowFlex™ products and other devices that use flexible materials to generate resistance, Nautilus™ equipment, Universal™ Weight machines, and other products that employ weights that slide up and down pulleys, tracks, bars, etc and other exercise equipment that uses gravity, friction, or mechanical devices, contrivances, etc. to generate resistance are commonly used in customer physical regimens. Services such as physical therapy, message, coaching, etc are also available in various locations from various venders. These are currently marketed in all of the conventional ways. However individuals lead busy lives and may be too focused on routine exercise to be aware of all that is offered within their physical exercise need circle. Therefore what are needed are electronic personal physical trainer systems and devices which are equipment and physical therapeutic and fitness training services aware in real-time, and that are sufficiently “intelligent” to understand the exercise regimen needs of clients and engage them at the user's personal regimen required time with internal as well as external commercial solutions.

### SUMMARY

The present invention discloses a business method for engaging a plurality of personal specific user physical exercise regimens with venders of products or services programmatically enhancing performance of the regimens through recommendations based on accepted personal physical exercise data. The system comprises a plurality of processed electronic personal exercise data, data programmatically triggered upon attaining set data band margins, limits or levels, triggered data margin bands/limits/levels signals which are programmatically mapped to trigger regimen advisories or recommendations, and regimen advisories or recommendations are programmatically mapped to vendor products and services such that individual and unique user physical performance regimens are improved adaptively through recommendations and recommendation supporting real-time vendor offerings of products and services. Vendors register with the model system, establish their preferred contact modes and recommendation remedies for anomalies, given symptom or discovered problems revealed by the tracked and processed regimen.

### BRIEF DESCRIPTION OF DRAWINGS

FIG. 1 is a high level flow diagram illustrating the physical regimen recommendation engine and business model according to an embodiment of the present invention.

FIG. 2 is a flow diagram illustrating the general physical exercise data process according to an embodiment of the present invention.

FIG. 3 is a high level context diagram illustrating the general data inputs and outputs according to an embodiment of the present invention.

FIG. 4 is an exemplar user input screen illustrating a typical internet screen interface according to an embodiment of the present invention.

FIG. 5 is an exemplar physical health product/service vender input screen illustrating a typical interface according to an embodiment of the present invention.

FIG. 6 is an exemplar user output screen illustrating a recommendation layout according to an embodiment of the present invention.

### DETAILED DESCRIPTION

Specific embodiments of the invention will now be described in detail with reference to the accompanying figures.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### OBJECTS AND ADVANTAGES

The present invention is a system and method of adaptively improving physical exercise regimes undertaken by users by analyzing exercise data for progress, and then offering recommendations which may or may not contain specific product or service solutions which are engaged with providers of the recommended product(s) or services in fulfillment of a user's unique physical exercise application needs at any particular instant in the regimen.

Physical exercise is by its nature a hands and body occupying activity. Therefore, devices that track and display activity will need to lend themselves to this nature. Therefore it is an objective of the invention to provide a hands free interface where possible by state of the art. Display devices may be wired flat screen monitors but they may also be handheld devices accessible wirelessly. Another objective of the invention is to provide contacts between users and vendors of equipment/services in real-time. Hence the handheld devices may be smart phones, providing direct means to communicate user needs to potential providers.

### FIGURES

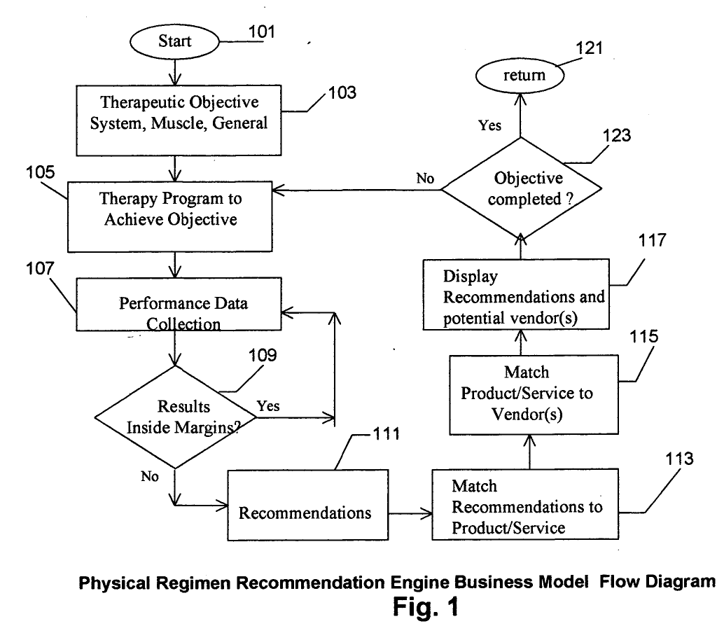

FIG. 1 is a high level flow diagram illustrating the physical regimen recommendation engine and business model according to an embodiment of the present invention. A model starts 101 with an individual's therapeutic objective 103, which spells out the physical system; cardio vascular, lungs, upper body, lower right leg, etc, muscle or general area which seeks improvement. A plan or regimen is crafted to improve or remedy the need and the individual is monitored during the prescribed regimen specific exercise for performance data 107. The prescribed exercise tracks progress and has automatic or selectable limits, bands and performance levels which are also tracked. Where certain flags are triggered, recommendations are programmatically issued 111. These recommendations are mapped to possible additional products or services 113 which can be helpful to either keep the individual on the path to improvement or help the individual improve faster. A search is made for potential available and reasonably accessible vendors 115 of the mapped products/services on the recommendation list. The recommendations and potential providers of specific additional useful aids are conveyed 117 to the individual, who decides if he/she wishes 123 to continue on the objective course 105 or they wish to discontinue 121 either temporarily or permanently. This is roughly the high level view of the exercise model, which seeks to help individuals control their own physical exercise regimen with timely programmable feedback on exercise for specific routines and knowledgeable market offerings related to remedial or performance enhancing products and services. Where bringing these major interests together facilitates a potential transaction, the model owner charges a finder fee.

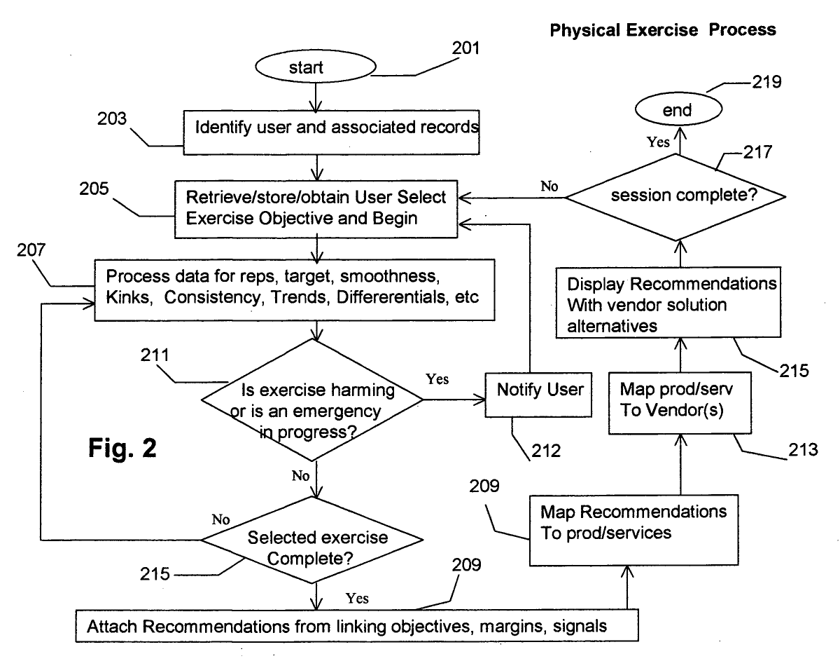

Turning to FIG. 2, a flow diagram for the general physical exercise data process according to an embodiment of the present invention is shown. An individual begins 201 by registering with the models service 203, where a user id account and associated individual records are created or transferred from another service. The individual is free to select his/her objective which will translate to one or more physical exercise routines or a regimen 205 which will help them reach their reasonable physical objective. As the individual engages the system with exercise routines in compliance with the regimen, the exercise data is collected and processed using the various applicable analytical methods such as Numerical Smoothness, Normalized Resistance Differential Smoothness, Time Differential Smoothness, Fast-twitch muscle fiber processes, Maximum Force, Locus segmentation, Strain energy, Power workload, Percentage of workload, and Endurance Measurements, Consistency, Scoring and comparative analysis. These are described in further detail in U.S. patent application Ser. No. 11/602,902, however, data processing is not limited to these techniques and proceeds in real-time along with physical exercise data acquisition, storage and retrieval. Continuous and periodic programmatic checks are made on the incoming exercise performance data for potentially harm induced signs 211 during the exercise regimen, or anomalies revealing underlying not outwardly visible weaknesses symptomatic of harmful developments. Any detected harm inducing exercise signals trigger notice 212 to individuals to take appropriate actions. Perhaps a lower level of exercise is recommended or a physical therapist/trainer's check is warranted. Otherwise upon completion of the exercise 215 recommendations stemming from progress towards the objectives, based on data within normal bands, are issued automatically and programmatically. Some recommendations will find associated mapped products and or services 209, which are then mapped to sets of listed vendors purporting to serve those particular and specific recommendations 213. Products and services which the individual listed having access to at registration are automatically consulted, to reduce redundancy. The recommendations along with any potential providers are displayed to the user 215. If the session is complete 217 the program ends and if not user is given the opportunity to select another objective 205 to work towards.

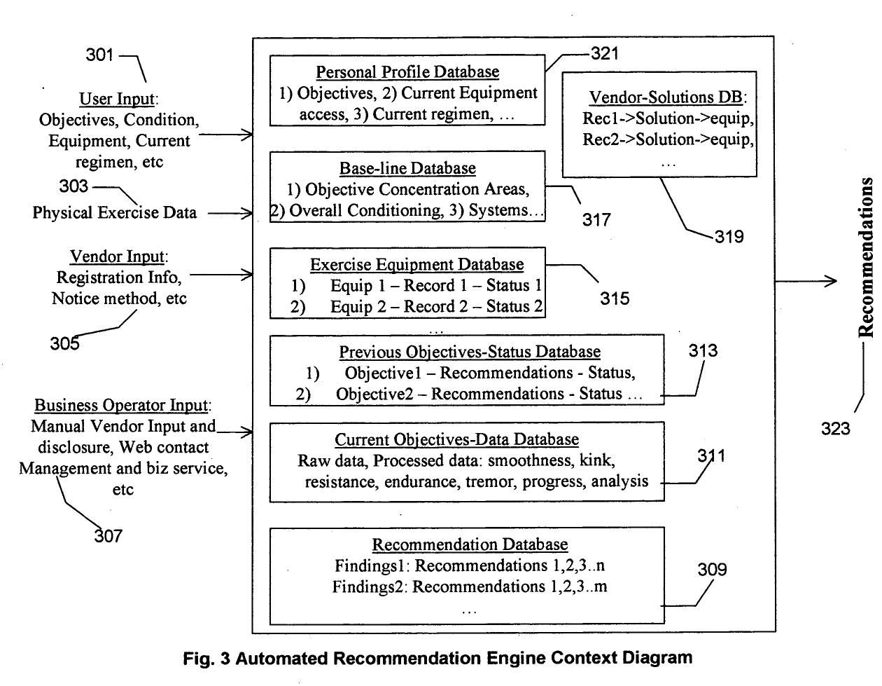

FIG. 3 is a high level context diagram illustrating the general data inputs and outputs according to an embodiment of the present invention. There are three basic input entities, User 301 303, Vendors 305 and Model Operator 307. Outputs are enclosed in Recommendations 323, which include outputs to users and in some embodiments can include vendors as well. User inputs 301 303 include the personal profile interview which can request user objectives, physical condition, accessible equipment, any current on-going regimens, etc. Upon entry, the user's physical exercise data 303 will provide the bulk of the input, although data can be retrieved from other previously generated sources and averages for any particular demographic and physical build category.

Vendor Input 305 will contain basic account information for administration management of the account, preferred contact information from users as well as the Operator, which may differ. The Operator 307 will administer and manage the business model through a networked architecture of devices. These will preferentially be Internet based. Administration functions will include responsibility for all computer programs, user and vendor account administration, contact and access management, providing user and vendor services and retaining a fee for user-vendor introductions and click stream for Internet based entities.

In an embodiment of a model system, several databases are used and are comprised of the Personal Profile Database 321, the Base-line Database 317, Exercise Equipment Database 315, Previous Objectives-Status Database 313, Current Objectives Database 311, Recommendations Database 309 and a Vendor-Solutions Database 319.

The Personal Profile Database 321 will contain the users account, access method, build features, demographics, exercise regimen budget, preferred location for services, physical condition, etc. Information here will be used to allow proper individual access and privacy, as well as some checks for contacts of important notifications. The Base-line Database 317 will contain information on initial test of maximum strength, number of times worked out and on what kinds of equipment. Data from external sources can be retrieved and used in conjunction with or in lieu of entrance testing. Comparative, trend and progress analysis can access this information to plot improvement or catch undetected subsurface problems.

The Exercise Equipment Database 315 will contain information on the type of equipment or services that the user has access to or has used in the past. This database is searched for potential recommendation available equipment before external sources are advised. The Previous Objectives-Status Database 313 contains information which can be obtained of users historical acceptance or treatment of previous recommendations. Repeat recommendations where not followed may not be effective, and other solutions maybe sought or preferred, where a user is not inclined to follow the recommendation for any reason. Although admonishment and encouragement may be a part of the recommendation aspect, user pre-dispositions are an element in physical training, and sometimes alternatives must given. The historical data can be used in many ways to craft new regimen and less then optimum regimen which are more likely to be adhered to. Therefore the previous objectives, recommendations for those and their associated status can be fields containing these data

A Current Objectives DataBase 311 will contain the raw incoming data associated with one or more objectives. These are sorted and processed for Numerical Smoothness, Normalized Resistance Differential Smoothness, Time Differential Smoothness, Fast-twitch muscle fiber, Maximum Force comparison, Locus segmentation, Strain energy, Power workload, Percentage of workload, Endurance Measurements, Consistency, Scoring and comparative analysis. The data processing is not limited to these techniques and proceeds in real-time along with physical exercise data acquisition, storage and retrieval. Continuous and periodic programmatic checks signal findings which trigger recommendations and notifications.

The Recommendation Database 309 is consulted with findings, having links to any number of solutions on a particular finding. The objective of a flatter stomach may have a recommended regimen of abdominal muscle exercises which can point to many types of equipment from free weights to machine manufacturer XYZ models A, B and C. The equipment will vary in cost, and the user's exercise budget may be consulted to most closely associate an affordable solution. The objective of cardio vascular training may have little effect from the user's accessible equipment. Hence a regimen prescribing lower body workouts such as a treadmill or stationary bicycles may be recommended at models within the user's budget from manufacturers with models within that budget.

The Vendor-Solution Database 319 is then consulted for affordable user solutions and that becomes the filter for the external equipment recommendation list.

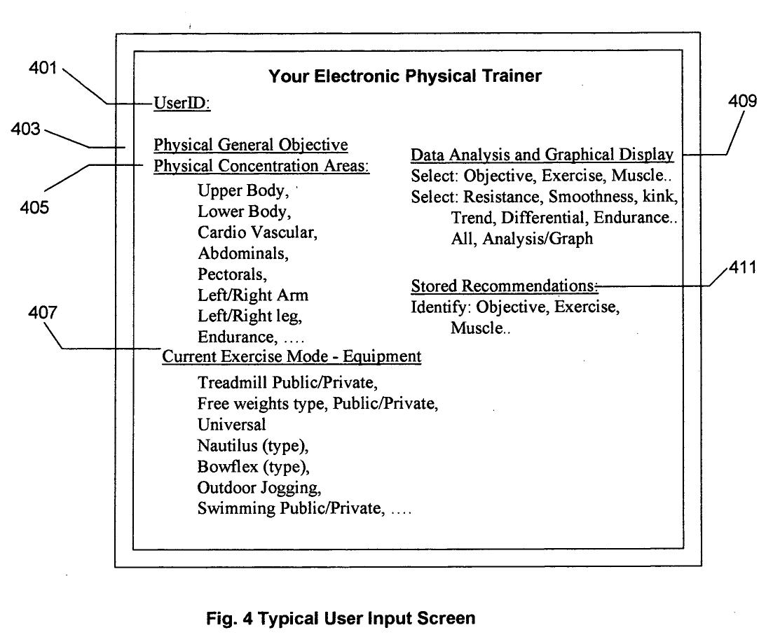

FIG. 4 is an exemplar user input screen illustrating a device screen interface according to an embodiment of the present invention. The user can login with a User ID 401 and associated password where he/she can access their General Objectives 403, Physical Concentration Areas 405, Current Exercise Mode—Equipment 407, Data Analysis and Graphical Display 409 or Stored Recommendation 411. The General Objectives 403 are broad user intents or goals such as rehabilitation, endurance, strength increase, weight control, etc. The Physical Concentration Area 405 narrow down to more specific physical systems, body locations or appendages; eg Upper Body, Lower Body, Cardiovascular, abdominals, left/right arm, leg, etc. The Current Exercise Mode—Equipment 407 outlines the equipment that the user is most likely to find useful with the prescribed regimen. Equipment can be owned by the user currently or the user may be have access to the equipment through a spa or other arrangement. The access information is obtained in the entrance interview and allows an aspect of the invention to craft a regimen using equipment accessible to the user if at all possible. Unavailable equipment or services can be part of the recommendations provided.

Data Analysis and Graphical Display 409 will provide visuals on previous exercise data and analysis of the data via the various numerical and statistical methods such as Numerical Smoothness, Normalized Resistance Differential Smoothness, Time Differential Smoothness, Fast-twitch muscle fiber, Maximum Force comparison, Locus segmentation, Strain energy, Power workload, Percentage of workload, Endurance Measurements, Consistency, Scoring and comparative analysis. These are all associated with particular areas and specific objectives which are also navigable to the user from this screen link. Selecting Stored Recommendations 411 will display previous objectives, exercise data associated with those objectives and for particular defined user physical areas.

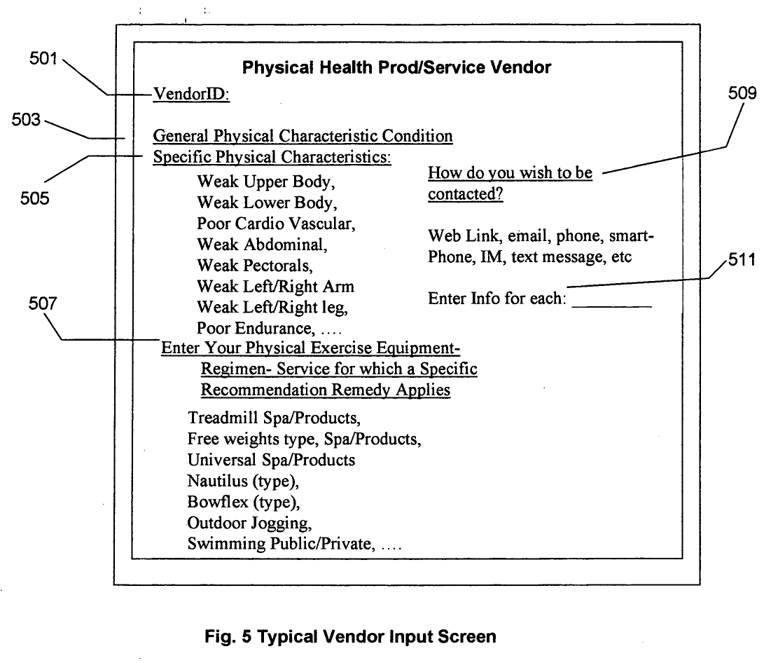

Turning to FIG. 5, shown is an exemplar physical health product/service vender input device screen illustrating an interface according to an embodiment of the present invention. Vendors can login with a Vendor ID 501 and associated password where he/she can access their account General Physical Characteristic Condition 503 listings, Specific Physical Characteristics 505 listings, Physical Exercise Equipment 507 listings, Contact Information 509 and access information 511 for each.

Vendor ID 501 are created much like other accounts, by registering and creating a password or restricting access by some method, be it password, biometric, etc. The General Physical Characteristic Condition 503 will provide a list of conditions for which the vendor sells products or services generally applicable and wishes to provide as part of recommended solutions. Specific Physical Characteristics 505 lists specific physical systems and areas which are symptomatic of weaknesses which may be strengthened by vendor products or services. The vendor can flag these for notification by users symptomatically indicating a need of attention in those specific recommended areas.

Exercise Equipment-Regimen-Service 507 for specific equipment recommendations can also be checked by vendors interested in users triggering recommendations for particular equipment which is not currently accessible to the users. Equipment manufactures will need to specify models and types, as some equipment is specific muscle or system targeting while other equipment can handle and is designed to handle many functions. Vendor contact 509 information is registered for preferred and various communication access modes such as weblink, email, phone, IM, text messaging, etc. Here a vendor's timely access by a user may mean a sale or no sale. An aspect of the invention encourages ?USERS?? and it behooves a vendor to provide product or service their customers via their communication 511 best mode.

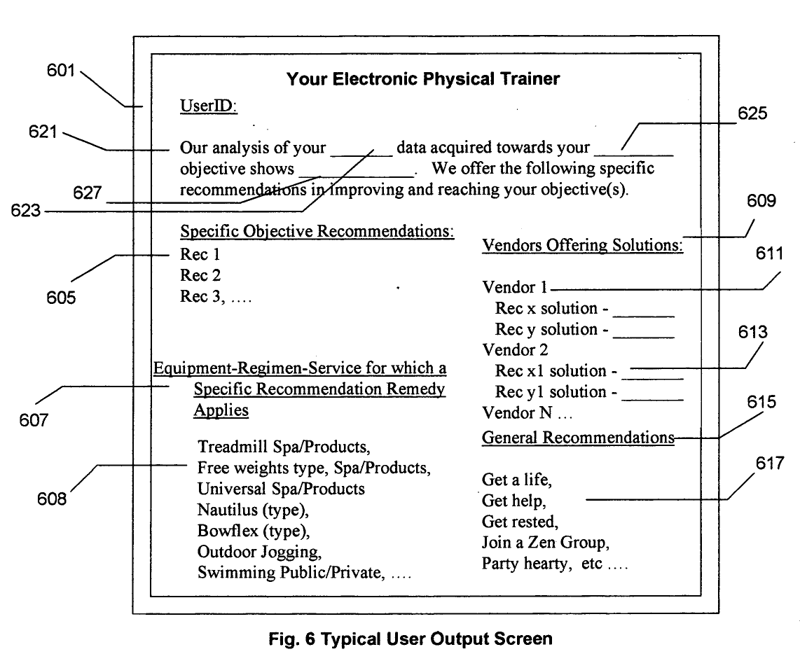

FIG. 6 is an exemplar user output screen illustrating a recommendation interface according to an embodiment of the present invention. The UserID 601 is similar to the previous mentioned user account information. The general recommendation preface 621 stating the user regimen 627 towards objective 625 and findings from data 623 serves to anchor the specific objective recommendation 605 provided. Many recommendations will be instructive on the current equipment used. Exceeded limits, margins and levels can have many ordinary use variances or advisories. Incorrect use, not properly finishing, relaxing toward the end of a pull, etc, can be remedied with simple informative admonishments. Where the recommendations can be implemented by user of certain exercise equipment, or service 607, these are listed 608 in addition to those. Vendors 609 section identifies and Vendor(s) 611 and their equipment/service descriptions/identification 613. A General Recommendations 615 section may also be present to encourage, admonish or inform users, regarding the attainment of objectives, general solutions for a physical problem or other advisories.

Therefore, while the invention has been described with respect to a limited number of embodiments, those skilled in the art, having benefit of this invention, will appreciate that other embodiments can be devised which do not depart from the scope of the invention as disclosed herein. Accordingly, the scope of the invention should be limited only by the attached claims. Other aspects of the invention will be apparent from the following description and the appended claims.

What is claimed is:

1. A system and business model for engaging a plurality of personal specific user physical exercise regimens with venders of products or services programmatically enhancing performance of the regimens through recommendations based on accepted personal physical exercise data comprising:
a plurality of processed electronic personal exercise data,
data programmatically triggered upon attaining set data band margins, limits or levels,
triggered data margins/limits/levels signals are programmatically mapped to trigger regimen advisories or recommendations, and
regimen advisories or recommendations programmatically mapped to vendor products and services
whereby individual and unique user physical performance regimens are improved adaptively through recommendations and recommendation supporting real-time vendor offerings of products and services.

2. A system as in claim 1 further comprising vendors self-updating offerings of products and services via Internet or other electronic communication mode.

3. A system as in claim 1 further comprising providing user with selection of listed vendor contact mode and methods including a Internet Website.

4. A system as in claim 1 further comprising vendor registration of product or service remedies to listed recommendations.

5. A system as in claim 1 further comprising statistical and mathematical processing of user exercise data for metadata on underlying physical maladies from statistical or mathematical characteristics of data indicative of impending or future physical problems, triggering programmatic scaled warnings enunciations.

6. A system as in claim 5 further wherein the processing of user data is selected from a group of analysis methods consisting of Numerical Smoothness, Normalized Resistance Differential Smoothness, Time Differential Smoothness, Fast-twitch muscle fiber processes, Maximum Force, Locus segmentation, Strain energy, Power workload, Percentage of workload, Consistency, Endurance Measurements and Scoring and comparative analysis.

7. A system as in claim 1 further comprising correlating previous recommendations with current performance data to ascertain unique level of user performance responsiveness to previous recommendations.

8. A system as in claim 7 further comprising accepting user inputs on degree of success or failure of previous applied recommendation towards a specified objective for adaptively tailoring recommendations.

9. A system as in claim 1 further comprising the user selectable mode and method of electronic automated reminder for regimen compliance.

10. A system as in claim 1 further comprising the ascertaining user available equipment to reduce superfluous or irreverent recommendations.

11. A method for facilitating a plurality of personal specific user physical exercise regimens with venders of products or services programmatically enhancing performance of the regimens through recommendations based on accepted personal physical exercise data further comprising the steps of:
obtaining a plurality of processed electronic personal exercise data,
programmatically signaling upon attaining set data band margins, limits or levels,
programmatically mapping to signaled associated regimen advisories or recommendations, and
programmatically mapping regimen advisories or recommendations to associated vendor products and services
whereby individual and unique user physical performance regimen improves performance adaptively through recommendations and recommendation supporting real-time vendor offerings of products and services.

12. A method as in claim 11 further comprising the steps of vendors self-updating offerings of products and services via Internet or other electronic communication mode.

13. A method as in claim 11 further comprising the steps of providing user with selection of listed vendor contact mode and methods including a Internet Website.

14. A method as in claim 11 further comprising the steps of vendor registration of product or service remedies to listed recommendations.

15. A method as in claim 11 further comprising the steps of statistical and mathematical processing of user exercise data for metadata on underlying physical maladies from statistical or mathematical characteristics of data indicative of impending or future physical problems, triggering programmatic scaled warnings enunciations.

16. A method as in claim 15 further wherein the steps of processing user data is selected from a group of analysis methods consisting of Numerical Smoothness, Normalized Resistance Differential Smoothness, Time Differential Smoothness, Fast-twitch muscle fiber processes, Maximum Force, Locus segmentation, Strain energy, Power workload, Percentage of workload, Consistency, Endurance Measurements and Scoring and comparative analysis.

17. A method as in claim 11 further comprising the steps of correlating previous recommendations with current performance data to ascertain unique level of user performance responsiveness to previous recommendations.

18. A method as in claim 17 further comprising the steps of accepting user inputs on degree of success or failure of previous applied recommendation towards a specified objective for adaptively tailoring recommendations.

19. A method as in claim 11 further comprising the steps of the user selecting mode and method of electronic automated reminder for regimen compliance.

20. A method as in claim 11 further comprising the steps of ascertaining user available equipment to reduce superfluous or irreverent recommendations.
